(19) United States
(12) Patent Application Publication
(10) Pub. No.: US 2024/0292358 A1
(43) Pub. Date: Aug. 29, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/585,053

(22) Filed: Feb. 23, 2024

(30) Foreign Application Priority Data
Feb. 28, 2023 (CN) 202310181367.7

(51) Int. Cl. H04W 56/00; H04L 1/00; H04W 72/232; H04W 74/0833; H04W 76/20

(52) U.S. Cl. CPC H04W 56/0045; H04L 1/0061; H04W 72/232; H04W 74/0833; H04W 76/20

(57) ABSTRACT

The present application discloses a method and a device in a communication node for wireless communications. The communication node triggers a first timing request; and cancels the first timing request when any condition in a first condition set is satisfied; the first timing request is used to determine a transmission timing for UL on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL. The solution proposed in the present application can trigger timing requests in a timely manner and avoid sending too many timing request signals.

### CROSS REFERENCE TO RELATED APPLICATIONS

This application claims the priority benefit of Chinese Patent Application No. 202310181367.7, filed on Feb. 28, 2023, the full disclosure of which is incorporated herein by reference.

### BACKGROUND

### Technical Field

The present application relates to transmission methods and devices in wireless communication systems, and in particular to a method and device for transmission timing in Uplink.

### Related Art

At the 94e meeting of the 3rd Generation Partner Project (3GPP) Radio Access Network (RAN), it was decided to study Layer 1/Layer 2 triggered mobility (L1/L2 Triggered Mobility, LTM) in the Work Item (WI) of “Further NR mobility enhancements”, including the management of Timing Advance (TA) for candidate cells. The 3GPP RAN94e meeting decided on studies of two-TA-based uplink multiple Transmit/Receive Point (multi-TRP/m-TRP) operations in the Work Item (WI) of “MIMO Evolution for Downlink and Uplink”.

### SUMMARY

In the existing protocol, the base station notifies the UE of timing advance updates through MAC CE commands, and when L1 (layer 1) is not synchronized, it can only send MSG1 or MSGA through the random access procedure. If the existing scheme is reused, the procedure of random access for candidate cells will have a large impact on the current communications. Therefore, the procedure of obtaining the transmission timing for the uplink for the candidate cells needs to be enhanced.

In response to the above problem, the present application provides a solution for transmission timing for Uplink. The description above only took NR system as an example, but this application is equally applicable to scenarios with the Long-Term Evolution (LTE) system, where similar technical effects can be achieved; furthermore, although the present application provides specific implementations for LTM only, it can also be used for scenarios like m-TRP, to achieve technical effects similar to LTM. Further, though originally intended for the Uu air interface, the present application also applies to the PC5 interface, to achieve technical effects similar to those at the Uu air interface. Further, although this application was originally intended for terminal-base station scenarios, it is equally applicable to Vehicle-to-Everything (V2X), terminal-relay communications, as well as relay-base station communication scenarios, to achieve technical effects similar to those in terminal-base station scenarios. Further, although this application was originally intended for terminal-base station scenarios, it is equally applicable to Integrated Access and Backhaul (IAB) communications, to achieve technical effects similar to those in terminal-base station scenarios. Further, although this application was originally intended for Terrestrial Network (TN) scenarios, it is equally applicable to Non-Terrestrial Network (NTN) communication scenarios, to achieve technical effects similar to those in TN scenarios. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
triggering a first timing request; and canceling the first timing request when any condition in a first condition set is satisfied;
herein, the first timing request is used to determine a transmission timing for uplink (UL) on a first cell.

In one embodiment, the first condition set comprises the first condition.

In one embodiment, the first condition set comprises the second condition.

In one embodiment, the first condition set comprises the third condition.

In one embodiment, the first condition set comprises at least one of the first condition or the second condition or the third condition.

In one embodiment, the first condition includes receiving a first signaling, the first signaling indicating a timing advance for the first cell.

In one embodiment, the second condition includes transmitting a first timing request signal on the first cell, the first timing request signal being a physical layer signal in UL.

In one embodiment, the third condition includes receiving a second signaling, the second signaling indicating a second cell, the second cell being different from the first cell.

In one embodiment, a problem to be solved in the present application includes: the procedure of obtaining the transmission timing for Uplink of candidate cells.

In one embodiment, the characteristics of the above method include: triggering a first timing request used to determine a transmission timing for Uplink on the first cell.

In one embodiment, the characteristics of the above method include: canceling the first timing request upon reception of a first signaling, the first signaling indicating a timing advance for the first cell.

In one embodiment, the characteristics of the above method include: canceling the first timing request when transmitting a first timing request signal on the first cell, the first timing request signal being a physical layer signal in UL.

In one embodiment, the characteristics of the above method include: canceling the first timing request upon reception of a second signaling, the second signaling indicating a second cell, the second cell being different from the first cell.

In one embodiment, an advantage of the above method includes: triggering a timing request in time.

In one embodiment, an advantage of the above method includes: avoiding transmission of too many timing request signals.

In one embodiment, an advantage of the above method includes: avoiding reusing random access procedure, reducing the impact on protocols.

In one embodiment, an advantage of the above method includes: ensuring lower complexity of implementation.

According to one aspect of the present application, characterized in comprising:
receiving a first Radio Resource Control (RRC) message, the first RRC message comprising configuration information for at least one candidate cell;
herein, the at least one candidate cell is/are configured for at least one serving cell of the first node; the first cell is a candidate cell of the at least one candidate cell.

In one embodiment, the characteristics of the above method include: when the first cell is one of the at least one candidate cell, “triggering a first timing request; and canceling the first timing request when any condition in a first condition set is satisfied;” is performed.

According to one aspect of the present application, characterized in that the first signaling is used to determine application of configuration information for the first cell.

In one embodiment, the characteristics of the above method include: canceling the first timing request when the first signaling indicates a timing advance for the first cell and the first signaling is used to determine the application of configuration information for the first cell.

According to one aspect of the present application, characterized in that the second signaling is used to determine application of configuration information for a second cell; the second cell is one of the at least one candidate cell.

In one embodiment, the characteristics of the above method include: canceling the first timing request when the second signaling indicates a second cell, the second cell being different from the first cell, and the second signaling is used to determine the application of configuration information for the second cell.

According to one aspect of the present application, characterized in that the first timing request is used to trigger transmission of the first timing request signal.

According to one aspect of the present application, characterized in comprising:
receiving a first DCI (i.e. Downlink Control Information), the first DCI indicating the first cell;
herein, the action of receiving a first DCI is used to trigger the first timing request.

According to one aspect of the present application, characterized in comprising:
a first timer being expired;
herein, the first timer being expired is used to trigger the first timing request; a running state of the first timer is used to determine whether Layer 1 (L1) of the first cell is synchronized.

According to one aspect of the present application, characterized in comprising:
transmitting a first measurement report after the action of receiving the first RRC message;
herein, the first measurement report is a signaling at a protocol layer below RRC sublayer.

The present application provides a method in a second node for wireless communications, comprising:
transmitting a first RRC message, the first RRC message comprising configuration information for at least one candidate cell;
herein, the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of the first condition or the second condition or the third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.

According to one aspect of the present application, characterized in that the first signaling is used to determine application of configuration information for the first cell.

According to one aspect of the present application, characterized in that the second signaling is used to determine application of configuration information for a second cell; the second cell is one of the at least one candidate cell.

According to one aspect of the present application, characterized in that the first timing request is used to trigger transmission of the first timing request signal.

According to one aspect of the present application, characterized in comprising:
transmitting a first DCI, the first DCI indicating the first cell;
herein, the action of receiving a first DCI is used to trigger the first timing request.

According to one aspect of the present application, characterized in that the first timer being expired is used to trigger the first timing request; a running state of the first timer is used to determine whether Layer 1 (L1) of the first cell is synchronized.

According to one aspect of the present application, characterized in comprising:
receiving a first measurement report after the action of transmitting the first RRC message;
herein, the first measurement report is a signaling at a protocol layer below RRC sublayer.

The present application provides a first node for wireless communications, comprising:
a first processor, triggering a first timing request; and canceling the first timing request when any condition in a first condition set is satisfied;
herein, the first timing request is used to determine a transmission timing for uplink (UL) on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

The present application provides a second node for wireless communications, comprising:
a second processor, transmitting a first RRC message, the first RRC message comprising configuration information for at least one candidate cell;
herein, the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of the first condition or the second condition or the third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.

In one embodiment, compared with the prior art, the present application is advantageous in the following aspects:
triggering a timing request in a timely manner;
avoiding transmission of too many timing request signals;
avoiding reusing of random access procedure, reducing the impact on protocols;
ensuring lower complexity of implementation.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first timing request according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission according to a third embodiment of the present application.

FIG. 8 illustrates a flowchart of radio signal transmission according to a fourth embodiment of the present application.

FIG. 9 illustrates a schematic diagram of a first signaling being used to determine the application of configuration information for a first cell according to one embodiment of the present application.

FIG. 10 illustrates a schematic diagram of a second signaling being used to determine the application of configuration information for a second cell according to one embodiment of the present application.

FIG. 11 illustrates a schematic diagram of a first timing request being used to trigger a first timing request signal according to one embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

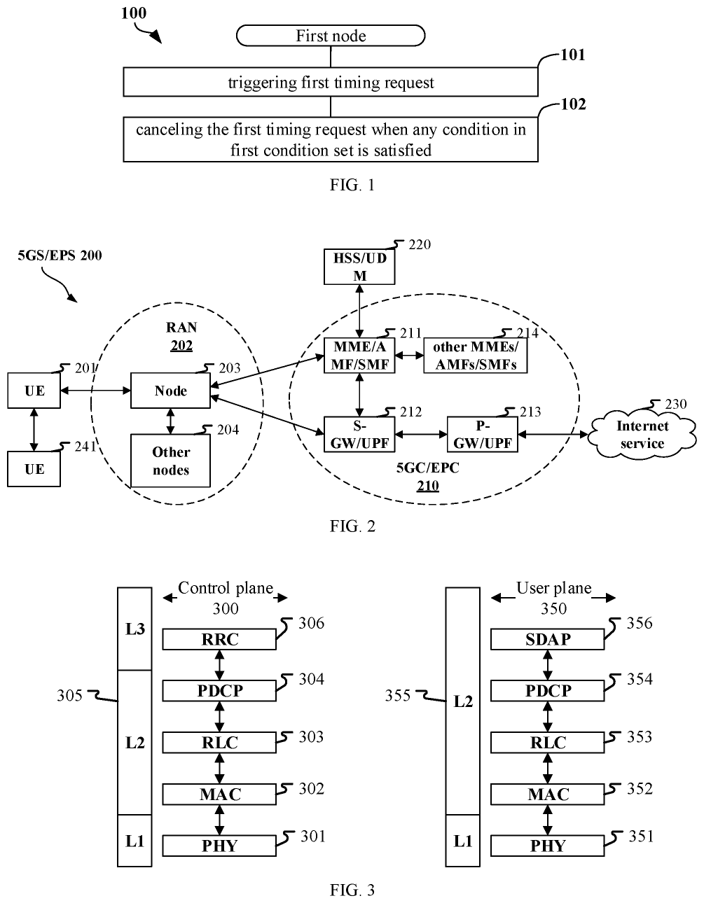

Embodiment 1 illustrates a flowchart of a first timing request according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application triggers a first timing request in step 101; and cancels the first timing request in step 102 when any condition in a first condition set is satisfied; herein the first timing request is used to determine a transmission timing for uplink (UL) on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

In one embodiment, the first timing request is triggered in a physical layer of the first node.

In one embodiment, the first timing request is triggered in a MAC sublayer of the first node.

In one embodiment, the first timing request is a timing request for the first cell.

In one embodiment, from the time the first timing request is triggered until the first timing request is canceled, the first timing request is pending.

In one embodiment, when the first timing request is triggered, the first timing request shall be considered as pending till the first timing request is canceled.

In one embodiment, when any condition in a first condition set is satisfied, the first timing request is pending.

In one embodiment, when any condition in a first condition set is satisfied, at least one timing request is pending, the first timing request being one of the at least one timing request.

In one embodiment, any condition in the first condition set being satisfied is used to determine cancellation of the first timing request.

In one embodiment, any condition in the first condition set being satisfied is used to determine cancellation of at least the first timing request.

In one embodiment, the first timing request signal is used to determine a timing advance on the first cell.

In one embodiment, the first timing request signal is used to trigger a timing advance on the first cell.

In one embodiment, the first timing request signal is used to request a timing advance on the first cell.

In one embodiment, the first timing request signal is used to obtain a timing advance on the first cell.

In one embodiment, the first timing request signal is used by the second node to calculate a timing advance on the first cell.

In one embodiment, a timing advance on the first cell is used to determine a transmission timing for Uplink on the first cell.

In one embodiment, the timing advance refers to: T_{A}.

In one embodiment, the timing advance refers to: the index value T_{A} used to control the amount of timing adjustment that the MAC entity has to apply.

In one embodiment, the timing advance is an index value.

In one embodiment, the first condition set comprises a first condition; the first condition includes receiving the first signaling, the first signaling indicating a timing advance for the first cell.

In one embodiment, the first condition set comprises a second condition; the second condition includes transmitting a first timing request signal on the first cell, the first timing request signal being a physical layer signal in UL.

In one embodiment, the first condition set comprises a third condition; the third condition includes receiving a second signaling, the second signaling indicating a second cell, the second cell being different from the first cell.

In one embodiment, the first condition set comprises at least one of the first condition or the second condition or the third condition.

In one embodiment, the first condition set comprises at least one of the first condition, the second condition or the third condition; besides, the first condition set does not comprise at least one of the first condition, the second condition or the third condition

In one embodiment, the first condition set comprises only the first condition of the first condition or the second condition or the third condition.

In one embodiment, the first condition set comprises only the second condition of the first condition or the second condition or the third condition.

In one embodiment, the first condition set comprises only the third condition of the first condition or the second condition or the third condition.

In one embodiment, the first condition set comprises only the first condition and the second condition of the first condition or the second condition or the third condition.

In one embodiment, the first condition set comprises only the first condition and the third condition of the first condition or the second condition or the third condition.

In one embodiment, the first condition set comprises only the second condition and the third condition of the first condition or the second condition or the third condition.

In one embodiment, the first condition set comprises the first condition, the second condition and the third condition.

In one embodiment, the first cell is a serving cell of the first node.

In one embodiment, the first cell is not a serving cell of the first node.

In one embodiment, the first cell is a neighboring cell of a serving cell of the first node.

In one embodiment, the first cell is a non-serving cell of the first node.

In one embodiment, the first cell is a candidate cell for a serving cell of the first node.

In one embodiment, the serving cell is a Special Cell (SpCell) of the first node.

In one embodiment, the SpCell is a Primary Cell (PCell).

In one embodiment, the SpCell is a Primary SCG Cell (PSCell).

In one embodiment, the serving cell is a Secondary cell (SCell).

In one embodiment, receiving the first signaling; and as a response to the first signaling being received, canceling the first timing request; the first condition set comprises a first condition.

In one embodiment, resetting of a MAC entity triggered by the first signaling is used to determine cancellation of the first timing request.

In one embodiment, as a response to the first signaling being received, resetting a MAC entity; the action of resetting the MAC entity includes canceling the first timing request.

In one embodiment, as a response to the first signaling being received, partially resetting a MAC entity; the action of partially resetting the MAC entity includes canceling the first timing request.

In one embodiment, resetting the MAC entity triggered by the first signaling does not include: setting the NDIs for all uplink HARQ processes to the value 0; or, resetting the MAC entity triggered by the first signaling does not include: initializing Bj for each logical channel to zero; or, resetting the MAC entity triggered by the first signaling does not include: considering all timeAlignmentTimers to be expired.

In one embodiment, the first signaling indicates the first cell and the first signaling indicates a timing advance.

In one embodiment, the first signaling indicates the first cell.

In one subembodiment, the first signaling explicitly indicates the first cell.

In one subembodiment, the first signaling implicitly indicates the first cell.

In one subembodiment, the first signaling indicates an identifier for the first cell.

In one subembodiment, the first signaling indicates an identifier associated with the first cell.

In one subembodiment, the first signaling indicates a cell identifier for the first cell.

In one subembodiment, the first signaling indicates a PCI for the first cell.

In one subembodiment, the first signaling indicates a candidate cell identifier for the first cell.

In one subembodiment, the first signaling indicates a candidate configuration identifier for the first cell.

In one subembodiment, the first signaling indicates a cell group to which the first cell belongs.

In one subembodiment, the first signaling indicates an identifier for a cell group to which the first cell belongs.

In one subembodiment, the first signaling indicates a candidate cell group to which the first cell belongs.

In one subembodiment, the first signaling indicates an identifier for a candidate cell group to which the first cell belongs.

In one subembodiment, the first signaling indicates a TAG to which the first cell belongs.

In one subembodiment, the first signaling indicates an ID of a TAG to which the first cell belongs.

In one embodiment, the first signaling comprises a timing advance, the timing advance being for the first cell.

In one embodiment, the first signaling comprises a timing advance, the timing advance being for a cell group to which the first cell belongs.

In one embodiment, the first signaling is an RRC message.

In one subembodiment, a logical channel for bearing the first signaling is a Dedicated Control Channel (DCCH).

In one subembodiment, the first signaling is an RRCReconfiguration message.

In one embodiment, the first signaling is an RRC field.

In one embodiment, the first signaling comprises a Timing Advance Command field, the Timing Advance Command field indicating a timing advance for the first cell.

In one embodiment, the first signaling comprises at least one Timing Advance Command field.

In one embodiment, the first signaling is a MAC sublayer signaling.

In one subembodiment, a DCI used to schedule the first signaling is identified by a Cell Radio Network Temporary Identifier (C-RNTI) of the first node.

In one subembodiment, a DCI used to schedule the first signaling is identified by a Random Access (RA)-RNTI.

In one subembodiment, a DCI used to schedule the first signaling is identified by a Message B RNTI (MSGB-RNTI).

In one subembodiment, the first signaling belongs to a same MAC subPDU.

In one subembodiment, the first signaling comprises a MAC subheader.

In one subembodiment, the first signaling is a MAC subPDU.

In one subembodiment, the first signaling does not comprise a MAC subheader.

In one subembodiment, the first signaling is a MAC Control Element (CE).

In one subembodiment, the first signaling is a MAC Random Access Response (RAR).

In one subembodiment, the first signaling is a MAC fallbackRAR.

In one subembodiment, the first signaling is a Timing Advance Command MAC CE.

In one subembodiment, the first signaling is an Absolute Timing Advance Command MAC CE.

In one subembodiment, the first signaling is at least one MAC Field.

In one subembodiment, the first signaling is identified by a Logical Channel ID (LCID), the LCID being an integer no less than 35 and no greater than 46.

In one subembodiment, the first signaling is identified by an eLCID, the eLCID being an integer no less than 210 and no greater than 226.

In one subembodiment, the first signaling is identified by a LCID, the LCID being 61.

In one subembodiment, the first signaling is identified by an eLCID, the eLCID being 252.

In one subembodiment, the first signaling is a MAC RAR.

In one embodiment, the first signaling is a physical layer signaling.

In one subembodiment, the first signaling is a DCI.

In one subembodiment, the first signaling is a DCI format 1_0.

In one subembodiment, the first signaling is a DCI format 1_1.

In one subembodiment, the first signaling is identified by a C-RNTI of the first node.

In one subembodiment, the first signaling is identified by a RA-RNTI.

In one subembodiment, the first signaling is identified by a MSGB-RNTI.

In one embodiment, the first signaling indicates a timing advance for at least one cell, the first cell being one of the at least one cell.

In one embodiment, the first signaling indicates a timing advance for a TAG to which the first cell belongs.

In one embodiment, the first signaling indicates a timing advance for only the first cell.

In one embodiment, transmitting the first timing request signal; and as a response to the first timing request signal being transmitted, canceling the first timing request; the first condition set comprises a second condition.

In one embodiment, the first timing request signal is an uplink signal.

In one embodiment, the first timing request signal is a physical layer signal.

In one embodiment, the first timing request signal occupies resources of a physical layer channel.

In one embodiment, the first timing request signal is a Preamble.

In one embodiment, the first timing request signal is a scheduling request (SR).

In one embodiment, the first timing request signal is a Sounding Reference Signal (SRS).

In one embodiment, a physical layer channel used for bearing the first timing request signal is a Physical Random Access Channel (PRACH).

In one embodiment, a physical layer channel used for bearing the first timing request signal is a Physical Uplink Control Channel (PUCCH).

In one embodiment, a physical layer channel used for bearing the first timing request signal is a Physical Uplink Shared Channel (PUSCH).

In one embodiment, receiving the second signaling; and as a response to the second signaling being received, canceling the first timing request; the first condition set comprises a third condition.

In one embodiment, the first timing request is a timing request for the first cell.

In one embodiment, a DCI that indicates one of the at least one candidate cell is used to trigger a timing request for the candidate cell.

In one embodiment, receiving a DCI, and if the DCI indicates one of the at least one candidate cell, triggering a timing request for the candidate cell.

In one embodiment, receiving a DCI, and if the DCI indicates one of the at least one candidate cell and the candidate cell is configured with an air interface resource for a timing request for the candidate cell, triggering a timing request for the candidate cell.

In one embodiment, the action of triggering a first timing request is used to trigger transmission of the first timing request signal.

In one embodiment, the first cell is a candidate cell.

In one embodiment, an air interface resource for a timing request for the candidate cell is configured by an RRC message.

In one embodiment, an air interface resource for a timing request for the candidate cell is indicated by DCI.

In one embodiment, the first condition set comprises a fourth condition, the fourth condition including resetting a MAC entity as requested by upper layers.

In one embodiment, the first condition set does not comprise a fourth condition.

In one embodiment, resetting a MAC entity as requested by upper layers includes cancellation of the first timing request.

In one embodiment, resetting a MAC entity is requested by upper layers; and as a response to being requested by upper layers to reset the MAC entity, canceling the first timing request.

In one embodiment, when resetting a MAC entity is requested by upper layers, the first timing request is pending.

In one embodiment, when resetting a MAC entity is requested by upper layers, canceling the first timing request.

In one embodiment, the action of resetting a MAC entity as requested by upper layers means: to reset a MAC entity to which a serving cell associated with the first cell belongs.

In one embodiment, the action of resetting a MAC entity as requested by upper layers means: to reset a MAC entity to which a serving cell configured for the first cell belongs.

In one embodiment, the action of resetting a MAC entity refers to: MAC reset as requested by upper layers.

In one embodiment, the action of resetting a MAC entity refers to: partial MAC reset.

In one embodiment, the action of resetting a MAC entity refers to: full MAC reset.

In one embodiment, determining at the upper layers an occurrence of a Radio Link Failure (RLF) in a serving cell associated with the first cell is used to determine resetting of a MAC entity.

In one embodiment, determining at the upper layers an occurrence of a Handover Failure (HOF) in a serving cell associated with the first cell is used to determine resetting of a MAC entity.

In one embodiment, determining at the upper layers that T304 has expired is used to determine resetting of a MAC entity.

In one embodiment, initiating an RRC connection re-establishment at the upper layers is used to determine resetting of a MAC entity.

In one embodiment, initiating an RRC connection re-establishment at the upper layers and attemptCondReconfig being not configured are used to determine resetting of a MAC entity.

In one embodiment, receiving an RRCRelease message that includes suspendConfig at the upper layers is used to determine resetting of a MAC entity

In one embodiment, receiving an RRCReject message at the upper layers is used to determine resetting of a MAC entity

In one embodiment, determining to enter into RRC_IDLE state at the upper layers is used to determine resetting of a MAC entity.

In one embodiment, determining the successful completion of the mobility from NR at the upper layers is used to determine resetting of a MAC entity.

In one embodiment, the upper layer includes an RRC sublayer.

In one embodiment, the upper layer is an RRC sublayer.

In one embodiment, when one condition in a first condition set is satisfied, canceling only the first timing request.

In one embodiment, when one condition in a first condition set is satisfied, canceling at least one timing request, the first timing request being one of the at least one timing request.

In one embodiment, when one condition in a first condition set is satisfied, canceling any timing request for the first cell, the first timing request being one timing request for the first cell.

In one embodiment, when one condition in a first condition set is satisfied, canceling at least one timing request that is pending, the first timing request being one of the at least one timing request that is pending.

In one embodiment, when one condition in a first condition set is satisfied, canceling any timing request that is pending, the first timing request being one timing request that is pending.

In one embodiment, when one condition in a first condition set is satisfied, canceling any timing request for the first cell that is pending, the first timing request being one timing request for the first cell that is pending.

In one embodiment, when one condition in a first condition set is satisfied, canceling any timing request for a Medium Access Control (MAC) entity associated with the first cell that is pending, the first timing request being one timing request for the first cell that is pending.

In one embodiment, when one condition in a first condition set is satisfied, canceling any timing request for any candidate cell that is pending.

In one embodiment, the above condition is the first condition.

In one embodiment, the above condition is the second condition.

In one embodiment, the above condition is the third condition.

In one embodiment, the above condition is the fourth condition.

In one embodiment, when the first condition is satisfied, canceling only the first timing request.

In one embodiment, when the first condition is satisfied, canceling any timing request for the first cell that is pending.

In one embodiment, when the first condition is satisfied, canceling any timing request for any candidate cell that is pending.

In one embodiment, when the second condition is satisfied, canceling only the first timing request.

In one embodiment, when the second condition is satisfied, canceling any timing request for the first cell that is pending.

In one embodiment, when the third condition is satisfied, canceling only the first timing request.

In one embodiment, when the third condition is satisfied, canceling any timing request for any candidate cell that is pending.

In one embodiment, when the third condition is satisfied, canceling any timing request for the first cell that is pending.

In one embodiment, the TAG refers to Timing Advance Group.

In one embodiment, the TAG refers to Time Alignment Group.

In one embodiment, the action of triggering a first timing request is used to trigger a timing request procedure.

In one embodiment, the action of triggering a first timing request belongs to a timing request procedure.

In one embodiment, the action of canceling the first timing request belongs to a timing request procedure.

In one embodiment, the first timing request is a timing request procedure.

In one embodiment, the timing request procedure is a random access procedure.

In one embodiment, the timing request procedure is not a random access procedure.

In one embodiment, the timing request procedure refers to the random access procedure in section 5.1 of TS 38.321.

In one embodiment, the timing request procedure does not refer to the random access procedure in section 5.1 of TS 38.321.

In one embodiment, the timing request procedure is not a legacy random access procedure.

In one embodiment, the timing request procedure is an enhanced random access procedure.

In one embodiment, the timing request procedure is a special random access procedure.

In one embodiment, the timing request procedure is a timing request procedure.

In one embodiment, the timing request procedure is a procedure of requesting uplink transmission timing.

In one embodiment, the timing request procedure is a timing advance procedure.

In one embodiment, the timing request procedure is a procedure for establishing time alignment.

In one embodiment, the timing request procedure is a procedure triggered by a PDCCH order.

In one embodiment, the timing request procedure comprises transmitting timing request signals.

### Embodiment 2

Embodiment 2 illustrates a schematic diagram of a network architecture according to one embodiment of the present application, as shown in FIG. 2. FIG. 2 is a diagram illustrating a network architecture 200 of 5G New Radio (NR), Long-Term Evolution (LTE) and Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise at least one of UEs 201, an RAN 202, a 5G Core

Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. RAN includes a node 203 and other nodes 204. The node 203 provides UE 201 oriented user plane and control plane terminations. The node 203 can be connected to other nodes 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a Centralized Unit (CU).

In one embodiment, the node 203 is a Distributed Unit (DU).

In one embodiment, the node 203 is a UE.

In one embodiment, the node 203 is a relay.

In one embodiment, the node 203 is a Gateway.

In one embodiment, the node 204 corresponds to the third node in the present application.

In one embodiment, the node 204 corresponds to the fourth node in the present application.

In one embodiment, the node 204 is a BS.

In one embodiment, the node 204 is a BTS.

In one embodiment, the node 204 is a NB.

In one embodiment, the node 204 is a gNB.

In one embodiment, the node 204 is an eNB.

In one embodiment, the node 204 is an ng-eNB.

In one embodiment, the node 204 is an en-gNB.

In one embodiment, the node 204 is a UE.

In one embodiment, the node 204 is a relay.

In one embodiment, the node 204 is a Gateway.

In one embodiment, the node 204 is a CU.

In one embodiment, the node 204 is a DU.

In one embodiment, the node 203 and the node 204 are connected to each other via ideal backhaul.

In one embodiment, the node 203 and the node 204 are connected to each other via non-ideal backhaul.

In one embodiment, the node 203 and the node 204 simultaneously provide wireless resources to the UE201.

In one embodiment, the node 203 and the node 204 do not simultaneously provide wireless resources to the UE201.

In one embodiment, the node 203 and the node 204 are the same node.

In one embodiment, the node 203 and the node 204 are two different nodes.

In one embodiment, the node 203 and the node 204 belong to a same CU.

In one embodiment, the node 203 and the node 204 belong to two different CUs.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are L1, L2 and L3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first timing request in the present application is triggered by the MAC302 or the MAC352.

In one embodiment, the first timing request in the present application is triggered by the PHY301 or the PHY351.

In one embodiment, the first signaling in the present application is generated by the RRC 306.

In one embodiment, the first signaling in the present application is generated by the MAC302 or the MAC352.

In one embodiment, the first signaling in the present application is generated by the PHY301 or the PHY351.

In one embodiment, the first timing request signal in the present application is generated by the PHY301 or the PHY351.

In one embodiment, the second signaling in the present application is generated by the RRC306.

In one embodiment, the second signaling in the present application is generated by the MAC302 or the MAC352.

In one embodiment, the second signaling in the present application is generated by the PHY301 or the PHY351.

In one embodiment, the first RRC message in the present application is generated by the RRC306.

In one embodiment, the first DCI in the present application is generated by the PHY301 or the PHY351.

In one embodiment, the first measurement report in the present application is generated by the RRC306.

In one embodiment, the first measurement report in the present application is generated by the MAC302 or the MAC352.

In one embodiment, the first measurement report in the present application is generated by the PHY301 or the PHY351.

### Embodiment 4

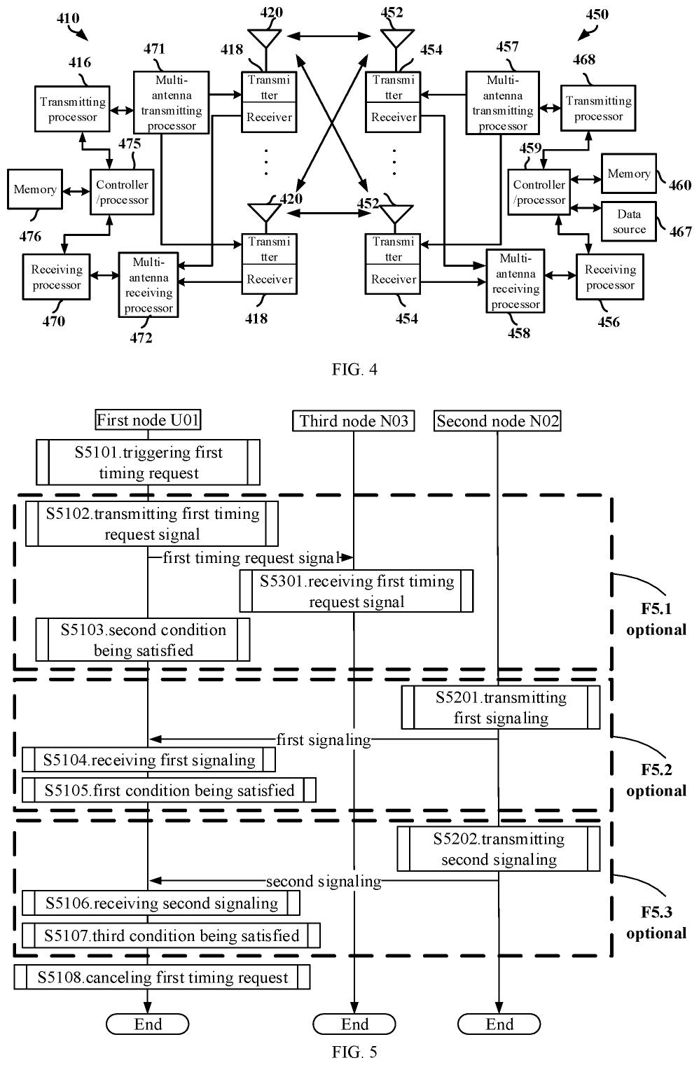

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least: triggers a first timing request; and cancels the first timing request when any condition in a first condition set is satisfied; herein, the first timing request is used to determine a transmission timing for uplink (UL) on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

In one embodiment, the first communication device 450 comprises a memory that stores computer readable instruction program, the computer readable instruction program generates actions when executed by at least one processor, which include: triggering a first timing request; and canceling the first timing request when any condition in a first condition set is satisfied; herein, the first timing request is used to determine a transmission timing for uplink (UL) on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first RRC message, the first RRC message comprising configuration information for at least one candidate cell; herein, the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of the first condition or the second condition or the third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.

In one embodiment, the second communication device 410 comprises a memory that stores computer readable instruction program, the computer readable instruction program generates an action when executed by at least one processor, which includes: transmitting a first RRC message, the first RRC message comprising configuration information for at least one candidate cell; herein, the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of the first condition or the second condition or the third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.

In one embodiment, at least one of the antenna 452, the transmitter 454, the transmitting processor 468 or the controller/processor 459 is used for triggering a first timing request.

In one embodiment, at least one of the antenna 452, the transmitter 454, the transmitting processor 468 or the controller/processor 459 is used for canceling a first timing request.

In one embodiment, at least one of the antenna 452, the receiver 454, the receiving processor 456, or the controller/processor 459 is used for receiving a first signaling.

In one embodiment, at least one of the antenna 420, the transmitter 418, the transmitting processor 416 or the controller/processor 475 is used for transmitting a first signaling;

In one embodiment, at least one of the antenna 452, the receiver 454, the receiving processor 456, or the controller/processor 459 is used for receiving a second signaling.

In one embodiment, at least one of the antenna 420, the transmitter 418, the transmitting processor 416 or the controller/processor 475 is used for transmitting a second signaling;

In one embodiment, at least one of the antenna 452, the receiver 454, the receiving processor 456, or the controller/processor 459 is used for receiving a first RRC message.

In one embodiment, at least one of the antenna 420, the transmitter 418, the transmitting processor 416 or the controller/processor 475 is used for transmitting a first RRC message.

In one embodiment, at least one of the antenna 452, the receiver 454, the receiving processor 456, or the controller/processor 459 is used for receiving a first DCI.

In one embodiment, at least one of the antenna 420, the transmitter 418, the transmitting processor 416 or the controller/processor 475 is used for transmitting a first DCI.

In one embodiment, at least one of the antenna 452, the transmitter 454, the transmitting processor 468 or the controller/processor 459 is used for transmitting a first timing request signal.

In one embodiment, at least one of the antenna 420, the receiver 418, the receiving processor 470, or the controller/processor 475 is used for receiving a first timing request signal.

In one embodiment, at least one of the antenna 452, the transmitter 454, the transmitting processor 468 or the controller/processor 459 is used for transmitting a first measurement report.

In one embodiment, at least one of the antenna 420, the receiver 418, the receiving processor 470, or the controller/processor 475 is used for receiving a first measurement report.

In one embodiment, the first communication device 450 corresponds to the first node in the present application.

In one embodiment, the second communication device 410 corresponds to a second node in the present application.

In one embodiment, the first communication device 450 is a UE.

In one embodiment, the first communication device 450 is a base station.

In one embodiment, the second communication device 410 is a UE.

In one embodiment, the second communication device 410 is a base station.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 triggers a first timing request in step S5101; and in step S5102, transmits a first timing request signal on the first cell, the first timing request signal being a physical layer signal in UL; in step S5103, a second condition is satisfied; and in step S5104, receives a first signaling, the first signaling indicating a timing advance for the first cell; in step S5105, a first condition is satisfied; and in step S5106, receives a second signaling, the second signaling indicating a second cell, the second cell being different from the first cell; in step S5107, a third condition is satisfied; and in step S5108, cancels the first timing request.

The second node N02 transmits the first signaling in step S5201; and transmits the second signaling in step S5202.

The third node N03 receives the first timing request signal in step S5301.

In Embodiment 5, the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

In one embodiment, the second node N02 and the third node N03 are co-located.

In one embodiment, the second node N02 and the third node N03 are non-co-located.

In one embodiment, the second node N02 and the third node N03 belong to a same DU.

In one embodiment, the second node N02 and the third node N03 belong to a same CU.

In one embodiment, the second node N02 and the third node N03 belong to different DUs.

In one embodiment, the second node N02 and the third node N03 belong to different CUs.

In one embodiment, the second node N02 is a maintenance base station for a serving cell of the first node U01.

In one embodiment, the second node N02 is a maintenance base station for the SpCell of the first node U01.

In one embodiment, the third node N03 is a maintenance base station for the first cell.

In one embodiment, the dotted-line box F5.1 is optional.

In one embodiment, the dotted-line box F5.1 does not exist.

In one embodiment, the dotted-line box F5.1 exists.

In one subembodiment, the dotted-line box F5.2 and the dotted-line box F5.3 don't exist.

In one embodiment, the dotted-line box F5.2 is optional.

In one embodiment, the dotted-line box F5.2 does not exist.

In one embodiment, the dotted-line box F5.2 exists.

In one subembodiment, the dotted-line box F5.1 and the dotted-line box F5.3 don't exist.

In one subembodiment, in the dotted-line box F5.1 the step S5102 exists, the step S5301 exists, while the step S5103 does not exist; the dotted-line box F5.3 does not exist.

In one subembodiment, before the step S5104, the first timing request signal is transmitted.

In one subembodiment, before the step S5104, the first timing request signal is not transmitted.

In one subembodiment, transmitting at least one physical layer signal on the first cell during a time interval from the step S5101 to the step S5104.

In one subembodiment, not transmitting any physical layer signal on the first cell during a time interval from the step S5101 to the step S5104.

In one subembodiment, the above physical layer signal is a timing request signal.

In one subembodiment, the above physical layer signal is a Preamble.

In one subembodiment, the above physical layer signal is an SRS.

In one subembodiment, the above physical layer signal is an SR.

In one subembodiment, the above physical layer signal is a PUCCH signal.

In one embodiment, the dotted-line box F5.3 is optional.

In one embodiment, the dotted-line box F5.3 does not exist.

In one embodiment, the dotted-line box F5.3 exists.

In one subembodiment, the dotted-line box F5.1 and the dotted-line box F5.2 don't exist.

In one subembodiment, in the dotted-line box F5.1 the step S5102 exists, the step S5301 exists, while the step S5103 does not exist; the dotted-line box F5.2 does not exist.

In one subembodiment, before the step S5106, the first timing request signal is transmitted.

In one subembodiment, before the step S5106, the first timing request signal is not transmitted.

In one subembodiment, transmitting at least one physical layer signal on the second cell during a time interval from the step S5101 to the step S5106.

In one subembodiment, not transmitting any physical layer signal on the second cell during a time interval from the step S5101 to the step S5106.

In one subembodiment, the above physical layer signal is a timing request signal.

In one subembodiment, the above physical layer signal is a Preamble.

In one subembodiment, the above physical layer signal is an SRS.

In one subembodiment, the above physical layer signal is an SR.

In one subembodiment, the above physical layer signal is a PUCCH signal.

### Embodiment 6

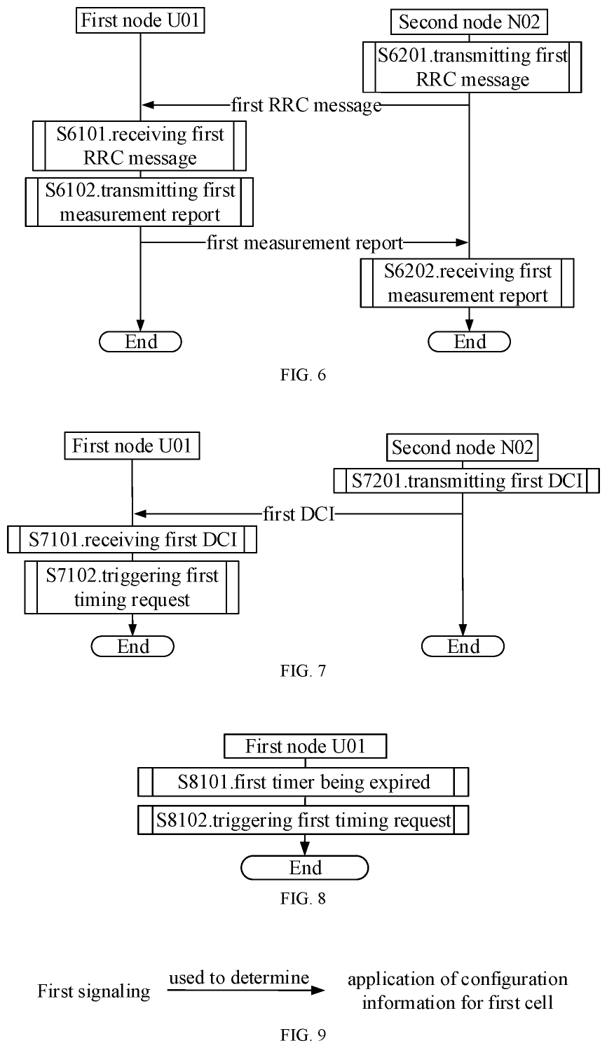

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first RRC message in step S6101, the first RRC message comprising configuration information for at least one candidate cell; and in step S6102, transmits a first measurement report after the action of receiving the first RRC message.

The second node N02 transmits the first RRC message in step S6201; and receives the first measurement report in step S6202.

In Embodiment 6, the at least one candidate cell is/are configured for at least one serving cell of the first node U01; the first cell is a candidate cell of the at least one candidate cell; the first measurement report is a signaling at a protocol layer below RRC sublayer.

In one embodiment, the first RRC message includes at least one RRC message.

In one embodiment, the first RRC message is an RRC message.

In one embodiment, the first RRC message comprises at least one RRC Information Element (IE).

In one embodiment, the first RRC message includes at least one RRC Field

In one embodiment, the first RRC message is transmitted via a Common Control Channel (CCCH).

In one embodiment, the first RRC message is transmitted via a Signaling Radio Bearer 1 (SRB1).

In one embodiment, the first RRC message is transmitted via a Signaling Radio Bearer 3 (SRB3).

In one embodiment, the first RRC message includes at least one RRCReconfiguration message.

In one embodiment, the first RRC message includes at least one RRCResume message.

In one embodiment, the first RRC message includes at least one RRCReestablishment message.

In one embodiment, the first RRC message includes at least one CellGroupConfig Field.

In one embodiment, the first RRC message includes at least one SpCellConfig Field.

In one embodiment, the first RRC message includes at least one reconfigurationWithSync field.

In one embodiment, the first RRC message includes at least one spCellConfigCommon field.

In one embodiment, the first RRC message comprises a ServingCellConfigCommon IE for each of the at least one candidate cell.

In one embodiment, the first RRC message comprises a DownlinkConfigCommon IE for each of the at least one candidate cell.

In one embodiment, the first RRC message comprises an UplinkConfigCommon IE for each of the at least one candidate cell.

In one embodiment, the first RRC message comprises a BWP-DownlinkCommon IE for each of the at least one candidate cell.

In one embodiment, the first RRC message comprises a BWP-UplinkCommon IE for each of the at least one candidate cell.

In one embodiment, the first RRC message comprises an ssb-PositionsInBurst field for each of the at least one candidate cell.

In one embodiment, the first RRC message comprises a candidate configuration identifier for each of the at least one candidate cell.

In one embodiment, each of the at least one candidate cell is configured with one candidate configuration identifier.

In one embodiment, any two of the at least one candidate cell have different candidate configuration identifiers.

In one embodiment, a candidate configuration identifier of any one of the at least one candidate cell is an integer no less than 0 and no greater than K1, K1 being a positive integer.

In one embodiment, K1 is equal to 8.

In one embodiment, K1 is equal to 16.

In one embodiment, the first RRC message does not indicate an air interface resource for the first timing request.

In one embodiment, the first RRC message indicates an air interface resource for the first timing request.

In one subembodiment, the first RRC message is used for configuring an air interface resource for the first timing request.

In one subembodiment, the first RRC message indicates an air interface resource for the first timing request signal.

In one subembodiment, the first RRC message is used for configuring an air interface resource used for the first timing request signal.

In one subembodiment, the air interface resource for the first timing request is pre-configured.

In one subembodiment, the first RRC message comprises air interface resource(s) for timing request(s) for one or more candidate cells of the at least one candidate cell.

In one embodiment, an air interface resource for a timing request for a cell comprises at least one of a time-domain resource or a frequency-domain resource or a code-domain resource for the timing request for the cell.

In one embodiment, an air interface resource for a timing request for a cell is used for transmitting a timing request signal for the timing request for the cell.

In one embodiment, an air interface resource for a timing request for a cell comprises an index of a timing request signal for the timing request for the cell.

In one embodiment, an air interface resource for a timing request for a cell comprises an uplink carrier associated with a timing request signal for the timing request for the cell.

In one embodiment, an air interface resource for a timing request for a cell comprises a PRACH mask for a timing request signal for the timing request for the cell.

In one embodiment, an air interface resource for a timing request for a cell comprises an SSB associated with a timing request signal for the timing request for the cell.

In one embodiment, the at least one serving cell is only one serving cell.

In one embodiment, the at least one serving cell is one or more serving cells.

In one embodiment, the at least one serving cell includes at least a SpCell.

In one embodiment, the at least one serving cell is a SpCell.

In one embodiment, the at least one serving cell belongs/belong to a same cell group.

In one embodiment, the at least one serving cell belongs/belong to a Master cell group (MCG).

In one embodiment, the at least one serving cell belongs/belong to a Secondary Cell Group (SCG).

In one embodiment, the at least one candidate cell is/are candidate cell(s) for each of the at least one serving cell.

In one embodiment, each of the at least one candidate cell is a LTM candidate cell.

In one embodiment, at least one of the at least one candidate cell is a Conditional Handover (CHO) candidate cell.

In one embodiment, at least one of the at least one candidate cell is a Conditional PSCell Change (CPC) candidate cell.

In one embodiment, the first cell is any candidate cell of the at least one candidate cell.

In one embodiment, the first cell is one of the at least one candidate cell that is indicated by the first DCI.

In one embodiment, after the action of receiving the first RRC message and before the action of receiving a first signaling, transmitting a first measurement report.

In one embodiment, the first measurement report is used for triggering the first signaling.

In one embodiment, a time of transmitting the first measurement report is earlier than a time of receiving the first signaling.

In one embodiment, the first measurement report comprises measurement results of at least the first cell.

In one embodiment, the first measurement report comprises measurement results of only the first cell.

In one embodiment, the first measurement report comprises measurement results of multiple cells, with the first cell being one of the multiple cells.

In one embodiment, the first measurement report indicates at least the first cell.

In one embodiment, the first measurement report comprises one identifier of at least the first cell.

In one embodiment, the first measurement report comprises one index of at least the first cell.

In one embodiment, the first measurement report is a piece of Uplink Control Information (UCI).

In one embodiment, the first measurement report is a MAC CE.

In one embodiment, the first measurement report is transmitted via a PUCCH.

In one embodiment, the first measurement report is transmitted via a PUSCH.

In one embodiment, the first measurement report is transmitted via an Uplink Shared Channel (UL-SCH).

In one embodiment, the first measurement report comprises L1 measurement results.

In one embodiment, the first measurement report is L1 measurement results.

In one embodiment, the L1 measurement results include a SS-RSRP measured for SSB.

In one embodiment, the L1 measurement results include a CSI-RSRP measured for Channel State Information-Reference Signal (CSI-RS).

In one embodiment, the L1 measurement results include filtered measurement results.

In one embodiment, the L1 measurement results include unfiltered measurement results.

In one embodiment, the L1 measurement results include a Reference Signal Received Power (RSRP).

In one embodiment, the L1 measurement results include a Reference Signal Receiving Quality (RSRQ).

In one embodiment, the L1 measurement results include a Signal-to-noise and interference ratio (SINR).

In one embodiment, the L1 measurement results include an L1-RSRP.

In one embodiment, the L1 measurement results include an L1-RSRQ.

In one embodiment, the L1 measurement results include an L1-SINR.

In one embodiment, the L1 measurement results include a measurement result of SSB.

In one embodiment, the SSB is Synchronization Signals (SS)/Physical broadcast channel (PBCH).

In one embodiment, the SSB is Synchronization Signals Block.

### Embodiment 7

Embodiment 7 illustrates a flowchart of signal transmission according to a third embodiment of the present application, as shown in FIG. 7. It should be particularly noted that the sequence illustrated herein does not set any limit to the signal transmission order or implementation order in the present application.

The first node U01 receives a first DCI in step S7101, the first DCI indicating the first cell; and triggers the first timing request in step S7102.

The second node N02 transmits the first DCI in step S7201.

In Embodiment 7, the action of receiving a first DCI is used to trigger the first timing request.

In one embodiment, a time of receiving the first DCI is no earlier than a time of receiving the first RRC message.

In one embodiment, a time of receiving the first DCI is later than a time of receiving the first RRC message.

In one embodiment, the first DCI is used for a Physical Downlink Control Channel (PDCCH) order.

In one embodiment, the first DCI is a PDCCH order.

In one embodiment, the first DCI is a PDCCH order used to trigger the first timing request.

In one embodiment, the first DCI is a PDCCH order used to trigger the first timing request signal.

In one embodiment, the first DCI is a PDCCH order used to trigger the first timing request procedure.

In one embodiment, the first DCI is identified by a first C-RNTI.

In one embodiment, the first DCI is scrambled by a first C-RNTI.

In one embodiment, the first DCI is addressed to a first C-RNTI.

In one embodiment, Cyclic Redundancy Check (CRC) of the first DCI is scrambled by a first C-RNTI.

In one embodiment, the first C-RNTI is a Cell Radio Network Temporary Identifier (C-RNTI) of the first node U01 in the SpCell.

In one embodiment, the first C-RNTI is a C-RNTI of the first node U01 in a cell group to which the SpCell belongs.

In one embodiment, the first DCI is in a format of DCI format 1_1.

In one embodiment, the first DCI is in a format of DCI format 1_0.

In one embodiment, the first DCI comprises at least one Identifier for DCI formats field, and, the Identifier for DCI formats field is set to 1.

In one embodiment, the first DCI comprises a Frequency domain resource assignment field, and, the Frequency domain resource assignment field is set to all-ones.

In one embodiment, the first DCI indicates an air interface resource for the first timing request.

In one subembodiment, the first DCI indicates an air interface resource for the first timing request signal.

In one subembodiment, the first DCI comprises at least one of a Random Access Preamble index field or an Uplink (UL)/Supplementary Uplink (SUL) indicator field or a SS/PBCH index field or a PRACH Mask index field.

In one embodiment, the first DCI does not indicate an air interface resource for the first timing request.

In one subembodiment, the first DCI does not comprise any of a Random Access Preamble index field or a UL/SUL indicator field or a SS/PBCH index field or a PRACH Mask index field.

In one embodiment, the first DCI indicates only the first cell of the at least one candidate cell.

In one embodiment, the first DCI indicates at least one of the at least one candidate cell, the first cell being one of the at least one candidate cell.

In one embodiment, the first DCI indicates multiple candidate cells of the at least one candidate cell, the first cell being one of the multiple candidate cells.

In one embodiment, the first DCI implicitly indicates the first cell.

In one embodiment, the first DCI explicitly indicates the first cell.

In one embodiment, the first DCI comprises a first DCI field, the value of the first DCI field being associated with the first cell.

In one subembodiment, the value of the first DCI field is indexed to the first cell.

In one subembodiment, the first DCI field indicates the first cell.

In one subembodiment, the first DCI field indicates a candidate configuration identifier for the first cell.

In one subembodiment, the first DCI field indicates a PCI for the first cell.

In one subembodiment, the first DCI field indicates an index of the first cell in the at least one candidate cell.

In one subembodiment, the first DCI field indicates a position of the first cell in the at least one candidate cell.

In one subembodiment, the first DCI field indicates a TAG to which the first cell belongs.

In one subembodiment, the first DCI field indicates a TAG ID to which the first cell belongs.

In one subembodiment, the first DCI field occupies at least 1 bit.

In one subembodiment, the first DCI field occupies 2 bits.

In one subembodiment, the first DCI field occupies 3 bits.

In one subembodiment, the first DCI field occupies 4 bits.

In one embodiment, as a response to the first DCI being received, triggering the first timing request.

In one embodiment, closely following the first DCI, triggering the first timing request.

In one embodiment, when the first DCI is received, triggering the first timing request.

In one embodiment, when the first DCI is received, a physical layer of the first node U01 sends an indication to a MAC sublayer of the first node U01; as a response to the MAC sublayer of the first node U01 receiving the indication, triggering the first timing request.

### Embodiment 8

Embodiment 8 illustrates a flowchart of signal transmission according to a fourth embodiment of the present application, as shown in FIG. 8. It should be particularly noted that the sequence illustrated herein does not set any limit to the signal transmission order or implementation order in the present application.

The first node U01 has a first timer being expired in step S8101; and triggers the first timing request in step S8102.

In Embodiment 8, the first timer being expired is used to trigger the first timing request; a running state of the first timer is used to determine whether Layer 1 (L1) of the first cell is synchronized.

In one embodiment, the first timer being expired means that a duration since the first timer was started has reached a maximum value of the first timer; where the first timer has not been restarted in the duration.

In one embodiment, the first timer being expired means that a duration since the first timer was restarted has reached a maximum value of the first timer; where the first timer has not been restarted in the duration. In one embodiment, the first timer being expired means that a value of the first timer has reached 0; the first timer counts down.

In one embodiment, the first timer being expired means that a value of the first timer has reached a maximum value of the first timer; the first timer counts time.

In one embodiment, the first timer is a MAC sublayer timer.

In one embodiment, the first timer is a Time Alignment Timer (TAT).

In one embodiment, the first timer is a timeAlignmentTimer.

In one embodiment, the first timer is a timer whose name includes timeAlignmentTimer.

In one embodiment, the first timer is associated with the first cell.

In one embodiment, the first timer is associated with at least the first cell.

In one subembodiment, one of the at least the first cell is a serving cell of the first node U01.

In one subembodiment, any of the at least the first cell is not a serving cell of the first node U01.

In one subembodiment, the at least the first cell belongs/belong to a same TAG.

In one subembodiment, the at least the first cell belongs/belong to a same candidate TAG.

In one subembodiment, the at least the first cell is/are pre-configured.

In one subembodiment, the at least the first cell is/are associated with a same identifier.

In one subembodiment, the at least the first cell is/are configured with a same identifier.

In one subembodiment, the same identifier is a TAG ID.

In one subembodiment, the same identifier is a candidate TAG ID.

In one subembodiment, the same identifier is a candidate configuration identifier.

In one embodiment, when the first timer expires, triggering the first timing request.

In one embodiment, each time when the first timer expires, triggering a timing request for the first cell.

In one embodiment, when at least the first timer expires and there is no pending timing request for the first cell, triggering a timing request for the first cell.

In one subembodiment, when the first timer expires, if there is at least no pending timing request for the first cell, triggering a timing request for the first cell.

In one subembodiment, when the first timer expires, as long as there is no pending timing request for the first cell, triggering a timing request for the first cell.

In one subembodiment, when the first timer expires, as long as there is at least one pending timing request for the first cell, a timing request for the first cell is not triggered.

In one embodiment, the first timer is used to determine a time interval at which the first node U01 considers the L1 of the first cell to be synchronized.

In one embodiment, the first timer is used to determine how long the first node U01 considers the L1 of the first cell to be synchronized.

In one embodiment, the first node U01 determines whether Layer 1 (L1) of the first cell is synchronized based on the running state of the first timer.

In one embodiment, when the first timer is running, the first node U01 considers L1 of the first cell to be synchronized.

In one embodiment, when the first timer is not running, the first node U01 considers L1 of the first cell to be non-synchronized.

In one embodiment, when the first timer is running, the first node U01 considers L1 of a TAG to which the first cell belongs to be synchronized.

In one embodiment, when the first timer is not running, the first node U01 considers L1 of a TAG to which the first cell belongs to be non-synchronized.

In one embodiment, the L1 synchronization refers to uplink alignment.

In one embodiment, the L1 synchronization refers to uplink synchronization in L1.

In one embodiment, the L1 non-synchronization means that the uplink is not aligned.

In one embodiment, the L1 non-synchronization means that the uplink is not synchronized in L1.

### Embodiment 9

Embodiment 9 illustrates a schematic diagram of a first signaling being used to determine the application of configuration information for a first cell according to one embodiment of the present application, as shown in FIG. 9.

In Embodiment 9, the first signaling is used to determine the application of configuration information for the first cell.

In one embodiment, receiving the first signaling; and as a response to the first signaling being received. applying the configuration information for the first cell.

In one embodiment, the first signaling indicates a timing advance for the first cell and the first signaling is used to determine the application of configuration information for the first cell.

In one embodiment, the first signaling is a LTM Command.

In one embodiment, the first signaling is a Handover Command.

In one embodiment, the first signaling indicates the first cell.

In one embodiment, the first signaling is used to indicate a switch to the first cell.

In one embodiment, the first signaling is used to indicate the application of configuration information of the first cell.

In one embodiment, the first signaling is a MAC subPDU.

In one embodiment, the first signaling is a MAC CE.

In one embodiment, a MAC subheader in a MAC subPDU to which the first signaling belongs indicates that the first signaling is used to determine the application of configuration information for the first cell.

In one embodiment, a MAC subheader in a MAC subPDU to which the first signaling belongs comprises a LCID field, the value of the LCID field indicating that the first signaling is used to determine the application of configuration information for the first cell.

In one embodiment, a MAC subheader in a MAC subPDU to which the first signaling belongs comprises an eLCID field, the value of the eLCID field indicating that the first signaling is used to determine the application of configuration information for the first cell.

### Embodiment 10

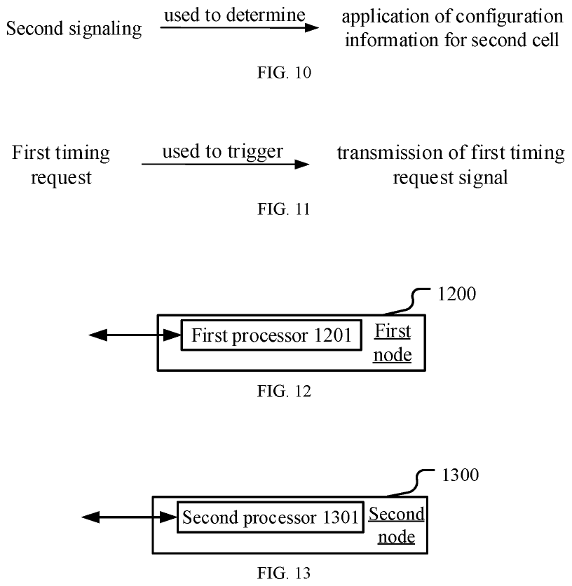

Embodiment 10 illustrates a schematic diagram of a second signaling being used to determine the application of configuration information for a second cell according to one embodiment of the present application, as shown in FIG. 10.

In Embodiment 10, the second signaling is used to determine application of configuration information for a second cell; the second cell is one of the at least one candidate cell.

In one embodiment, receiving the second signaling; and as a response to the second signaling being received, applying the configuration information for the second cell.

In one embodiment, the second signaling indicates a timing advance for the second cell and the second signaling is used to determine the application of configuration information for the second cell.

In one embodiment, the second signaling does not indicate a timing advance for the second cell and the second signaling is used to determine the application of configuration information for the second cell.

In one embodiment, the second signaling is a LTM Command.

In one embodiment, the second signaling is a Handover Command.

In one embodiment, the second signaling indicates the second cell.

In one embodiment, the second signaling is used to indicate a switch to the second cell.

In one embodiment, the second signaling is used to indicate the application of configuration information for the second cell.

In one embodiment, the second signaling is a MAC subPDU.

In one embodiment, the second signaling is a MAC CE.

In one embodiment, a MAC subheader in a MAC subPDU to which the second signaling belongs indicates that the second signaling is used to determine the application of configuration information for the second cell.

In one embodiment, a MAC subheader in a MAC subPDU to which the second signaling belongs comprises a Logical Channel ID (LCID) field, the value of the LCID field indicating that the second signaling is used to determine the application of configuration information for the second cell.

In one embodiment, a MAC subheader in a MAC subPDU to which the second signaling belongs comprises an extended LCID (eLCID) field, the value of the eLCID field indicating that the second signaling is used to determine the application of configuration information for the second cell.

In one embodiment, the first signaling and the second signaling are in a same format.

In one embodiment, the value of a LCID field in a MAC subheader in a MAC subPDU to which the second signaling belongs is equal to the value of a LCID field in a MAC subheader in a MAC subPDU to which the first signaling belongs.

In one embodiment, the first signaling and the second signaling are in different formats.

In one embodiment, the value of a LCID field in a MAC subheader in a MAC subPDU to which the second signaling belongs is unequal to the value of a LCID field in a MAC subheader in a MAC subPDU to which the first signaling belongs.

### Embodiment 11

Embodiment 11 illustrates a schematic diagram of a first timing request being used to trigger a first timing request signal according to one embodiment of the present application, as shown in FIG. 11.

In Embodiment 11, the first timing request is used to trigger transmission of the first timing request signal.

In one embodiment, as a response to the first timing request being triggered, transmitting the first timing request signal.

In one embodiment, the first timing request being triggered is used to trigger transmission of the first timing request signal.

In one embodiment, as a response to the first timing request being triggered, transmitting the first timing request signal.

In one embodiment, that the first timing request is pending is used to trigger transmission of the first timing request signal.

In one embodiment, as a response to the first timing request being pending, transmitting the first timing request signal.

In one embodiment, at least one timing request for the first cell is used to trigger transmission of the first timing request signal; the first timing request is one of the at least one timing request for the first cell.

In one subembodiment, that at least one timing request for the first cell is pending is used to trigger transmission of the first timing request signal.

In one subembodiment, that at least one timing request for the first cell is triggered is used to trigger transmission of the first timing request signal.

In one subembodiment, as a response to at least one timing request for the first cell being triggered, transmitting the first timing request signal.

In one subembodiment, as a response to at least one timing request for the first cell being pending, transmitting the first timing request signal.

In one embodiment, transmitting the first timing request signal at a transmission occasion of the first timing request signal.

In one embodiment, the transmission occasion of the first timing request signal depends on the air interface resource for the first timing request.

### Embodiment 12

Embodiment 12 illustrates a structure block diagram of a processing device used in a first node according to one embodiment of the present application, as shown in FIG. 12. In FIG. 12, a processing device 1200 in the first node comprises a first processor 1201.

The first processor 1201 triggers a first timing request; and cancels the first timing request when any condition in a first condition set is satisfied.

In Embodiment 12, the first timing request is used to determine a transmission timing for uplink (UL) on a first cell; the first condition set comprises at least one of the first condition or the second condition or the third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

In one embodiment, the first processor 1201 receives a first RRC message, the first RRC message comprising configuration information for at least one candidate cell; herein, the at least one candidate cell is configured for at least one serving cell of the first node; the first cell is a candidate cell of the at least one candidate cell.

In one embodiment, the first signaling is used to determine the application of configuration information for the first cell.

In one embodiment, the second signaling is used to determine application of configuration information for a second cell; the second cell is one of the at least one candidate cell.

In one embodiment, the first timing request is used to trigger transmission of the first timing request signal.

In one embodiment, the first processor 1201 receives a first DCI, the first DCI indicating the first cell; herein, the action of receiving a first DCI is used to trigger the first timing request.

In one embodiment, the first processor 1201 where a first timer expires; herein, the first timer being expired is used to trigger the first timing request; a running state of the first timer is used to determine whether Layer 1 (L1) of the first cell is synchronized.

In one embodiment, the first processor 1201, after the action of receiving the first RRC message, transmits a first measurement report; herein, the first measurement report is a signaling at a protocol layer below RRC sublayer.

In one embodiment, the first processor 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first processor 1201 comprises the antenna 452, the receiver 454, the multi-antenna receiving processor 458 and the receiving processor 456 in FIG. 4 of the present application.

In one embodiment, the first processor 1201 comprises the antenna 452, the receiver 454 and the receiving processor 456 in FIG. 4 of the present application.

In one embodiment, the first processor 1201 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first processor 1201 comprises the antenna 452, the transmitter 454, the multi-antenna transmitting processor 457 and the transmitting processor 468 in FIG. 4 of the present application.

In one embodiment, the first processor 1201 comprises the antenna 452, the transmitter 454 and the transmitting processor 468 in FIG. 4 of the present application.

### Embodiment 13

Embodiment 13 illustrates a structure block diagram of a processing device used in a second node according to one embodiment of the present application, as shown in FIG. 13. In FIG. 13, a processing device 1300 in the second node comprises a second processor 1301.

The second processor 1301 transmits a first RRC message, the first RRC message comprising configuration information for at least one candidate cell.

In Embodiment 13, the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of the first condition or the second condition or the third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.

In one embodiment, the first signaling is used to determine the application of configuration information for the first cell.

In one embodiment, the second signaling is used to determine application of configuration information for a second cell; the second cell is one of the at least one candidate cell.

In one embodiment, the first timing request is used to trigger transmission of the first timing request signal.

In one embodiment, the second processor 1301 transmits a first DCI, the first DCI indicating the first cell; herein, the action of receiving a first DCI is used to trigger the first timing request.

In one embodiment, the first timer being expired is used to trigger the first timing request; a running state of the first timer is used to determine whether Layer 1 (L1) of the first cell is synchronized.

In one embodiment, the second processor 1301, after the action of transmitting the first RRC message. receives a first measurement report; herein, the first measurement report is a signaling at a protocol layer below RRC sublayer.

In one embodiment, the second processor 1301 comprises the antenna 420, the transmitter 418, the multi-antenna transmitting processor 471, the transmitting processor 416, the controller/processor 475 and the memory 476 in FIG. 4 of the present application.

In one embodiment, the second processor 1301 comprises the antenna 420, the transmitter 418, the multi-antenna transmitting processor 471 and the transmitting processor 416 in FIG. 4 of the present application.

In one embodiment, the second processor 1301 comprises the antenna 420, the transmitter 418 and the transmitting processor 416 in FIG. 4 of the present application.

In one embodiment, the second processor 1301 comprises the antenna 420, the receiver 418, the multi-antenna receiving processor 472, the receiving processor 470, the controller/processor 475 and the memory 476 in FIG. 4 of the present application.

In one embodiment, the second processor 1301 comprises the antenna 420, the receiver 418, the multi-antenna receiving processor 472 and the receiving processor 470 in FIG. 4 of the present application.

In one embodiment, the second processor 1301 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP). and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first processor, triggering a first timing request; and canceling the first timing request when any condition in a first condition set is satisfied;
wherein the first timing request is used to determine a transmission timing for uplink (UL) on a first cell; the first condition set comprises at least one of a first condition or a second condition or a third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

2. The first node according to claim 1, characterized in comprising:
the first processor, receiving a first Radio Resource Control (RRC) message, the first RRC message comprising configuration information for at least one candidate cell;
wherein the at least one candidate cell is/are configured for at least one serving cell of the first node; the first cell is a candidate cell of the at least one candidate cell.

3. The first node according to claim 2, characterized in that the first RRC message comprises at least one RRCReconfiguration message; the at least one serving cell is a Special Cell (SpCell).

4. The first node according to claim 2, characterized in that each of the at least one candidate cell is a L1/L2 Triggered Mobility (LTM) candidate cell; or at least one of the at least one candidate cell is a Conditional Handover (CHO) candidate cell; or, at least one of the at least one candidate cell is a Conditional PSCell Change (CPC) candidate cell.

5. The first node according to claim 2, characterized in that the first RRC message comprises an air interface resource for a timing request for one or more of the at least one candidate cell; the air interface resource for a timing request for one cell comprises an index of a timing request signal for the timing request for the cell; the air interface resource for a timing request for one cell comprises a SSB associated with a timing request signal for the timing request for the cell.

6. The first node according to claim 1, characterized in that the first signaling indicates the first cell and the first signaling indicates a timing advance.

7. The first node according to claim 2, characterized in that the first signaling is used to determine application of configuration information for the first cell.

8. The first node according to claim 2, characterized in that the second signaling is used to determine application of configuration information for a second cell; the second cell is one of the at least one candidate cell.

9. The first node according to claim 1, characterized in that the first timing request is used to trigger transmission of the first timing request signal.

10. The first node according to claim 1, characterized in comprising:
the first processor, receiving a first DCI (i.e., downlink control information), the first DCI indicating the first cell;
wherein the action of receiving a first DCI is used to trigger the first timing request.

11. The first node according to claim 1, characterized in that a Cyclic Redundancy Check (CRC) of the first DCI is scrambled by a first C-RNTI; the first C-RNTI is a Cell Radio Network Temporary Identifier (C-RNTI) of the first node in a SpCell.

12. The first node according to claim 1, characterized in that the first DCI indicates an air interface resource for the first timing request; the air interface resource for the first timing request comprises an index of a timing request signal for the first timing request; the air interface resource for the first timing request comprises an SSB associated with a timing request signal for the first timing request.

13. The first node according to claim 1, characterized in comprising:
the first processor, where a first timer is expired;
wherein the first timer being expired is used to trigger the first timing request; a running state of the first timer is used to determine whether Layer 1 (L1) of the first cell is synchronized.

14. The first node according to claim 1, characterized in comprising:
the first processor, transmitting a first measurement report after the action of receiving the first RRC message;
wherein the first measurement report is a signaling at a protocol layer below RRC sublayer.

15. The first node according to claim 1, characterized in comprising:
the first processor, transmitting the first timing request signal on the first cell, the first timing request signal being a physical layer signal in UL;
wherein the second condition is satisfied.

16. The first node according to claim 1, characterized in that the first timing request signal is a Preamble.

17. The first node according to claim 1, characterized in that the first cell is a candidate cell for a serving cell of the first node; the serving cell is a SpCell of the first node; the SpCell is a PCell, or the SpCell is a PSCell.

18. The first node according to claim 1, characterized in that the first timing request is a timing request procedure; the timing request procedure is a random access procedure.

19. A method in a first node for wireless communications, comprising:
triggering a first timing request; and canceling the first timing request when any condition in a first condition set is satisfied;
wherein the first timing request is used to determine a transmission timing for uplink (UL) on a first cell; the first condition set comprises at least one of a first condition or a second condition or a third condition; the first condition includes receiving a first signaling, the first signaling indicating a timing advance for the first cell; the second condition includes transmitting a first timing request signal on the first cell, the first timing request signal being a physical layer signal in UL; the third condition includes receiving a second signaling, the second signaling indicating a second cell, the second cell being different from the first cell.

20. A second node for wireless communications, comprising:
a second processor, transmitting a first RRC message, the first RRC message comprising configuration information for at least one candidate cell;
wherein the at least one candidate cell is/are configured for at least one serving cell of a receiver of the first RRC message; a first cell is a candidate cell of the at least one candidate cell; a first timing request is triggered; when any condition in a first condition set is satisfied, the first timing request is canceled; the first timing request is used to determine a transmission timing for UL on the first cell; the first condition set comprises at least one of a first condition or a second condition or a third condition; the first condition includes a first signaling being received by the receiver of the first RRC message, the first signaling indicating a timing advance for the first cell; the second condition includes a first timing request signal being transmitted by the receiver of the first RRC message on the first cell, the first timing request signal being a physical layer signal in UL; the third condition includes a second signaling being received by the receiver of the first RRC message, the second signaling indicating a second cell, the second cell being different from the first cell.
